(19) United States
(12) Patent Application Publication
(10) Pub. No.: US 2025/0321993 A1
(43) Pub. Date: Oct. 16, 2025

(54) INFORMATION PROCESSING APPARATUS, INFORMATION PROCESSING METHOD, AND NON-TRANSITORY COMPUTER READABLE STORAGE MEDIUM

(71) Applicant: LY Corporation, Tokyo (JP)

(72) Inventors: Kazuhiro HATAKEDA, Tokyo (JP); Chiho IWAHASHI, Tokyo (JP); Kenta MURAKAMI, Tokyo (JP); Misato SASAKI, Tokyo (JP); Toshinori MIYOSHI, Tokyo (JP)

(21) Appl. No.: 19/020,265

(22) Filed: Jan. 14, 2025

(30) Foreign Application Priority Data
Jan. 19, 2024 (JP) 2024-007006

(51) Int. Cl. G06F 16/3329; G06F 40/284

(52) U.S. Cl. CPC G06F 16/33295; G06F 40/284

(57) ABSTRACT

An information processing apparatus according to the present application includes a generation unit, a reception unit, and a determination unit. The generation unit generates non-response target information indicating a non-response target. The reception unit receives information indicating a request of a user. The determination unit determines, based on a plurality of pieces of non-response target information generated by the generation unit, whether the request indicated by the information received by the reception unit is a request concerning a non-response target.

### CROSS-REFERENCE TO RELATED APPLICATIONS

The present application claims priority to and incorporates by reference the entire contents of Japanese Patent Application No. 2024-007006 filed in Japan on Jan. 19, 2024.

### BACKGROUND OF THE INVENTION

### 1. Field of the Invention

The present invention relates to an information processing apparatus, an information processing method, and a non-transitory computer-readable storage medium.

### 2. Description of the Related Art

In recent years, a technology for responding to a request from a user using a language model such as a transformer model has been developed. For example, Japanese Patent No. 7353695 discloses a technique for causing a language model to generate an answer to a question.

However, in the related art explained above, measures taken when it is inappropriate to perform a response such as an answer are not considered, and there is room for improvement.

### SUMMARY OF THE INVENTION

An information processing apparatus according to the present application includes a generation unit, a reception unit, and a determination unit. The generation unit generates non-response target information indicating a non-response target. The reception unit receives information indicating a request of a user. The determination unit determines, based on a plurality of pieces of non-response target information generated by the generation unit, whether the request indicated by the information received by the reception unit is a request concerning a non-response target.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram for explaining information processing according to an embodiment;

FIG. 2 is a diagram illustrating an example of a configuration of an information processing system according to the embodiment;

FIG. 3 is a diagram illustrating an example of a configuration of an information processing apparatus according to the embodiment;

FIG. 4 is a diagram illustrating an example of a user information table stored in a user information storage unit of the information processing apparatus according to the embodiment;

FIG. 5 is a diagram illustrating an example of a non-response target table stored in the non-response target information storage unit of the information processing apparatus according to the embodiment;

FIG. 6 is a diagram illustrating an example of non-response categories set in advance for categories in the information processing apparatus according to the embodiment;

FIG. 7 is a diagram illustrating an example of instruction information used by a first generation processing unit in a processing unit of the information processing apparatus according to the embodiment and an output example of a third language model;

FIG. 8 is a diagram illustrating an example of instruction information used by a second generation processing unit in the processing unit of the information processing apparatus according to the embodiment and an output example of the third language model;

FIG. 9 is a diagram illustrating a relationship of processing by the first generation processing unit and the second generation processing unit in the processing unit of the information processing apparatus according to the embodiment;

FIG. 10 is a diagram illustrating an example of instruction information used by a third generation processing unit and an output example of the third language model in the processing unit of the information processing apparatus according to the embodiment and is a diagram illustrating an example in a case in which a request indicated by request information is a question in a Q & A service and non-response category information is a character string “question concerning the Internet”;

FIG. 11 is a diagram illustrating an example of instruction information used for explicit non-response determination processing performed by a fourth generation processing unit of the processing unit in the information processing apparatus according to the embodiment as part of processing of a determination unit;

FIG. 12 is a diagram illustrating a flow of processing by an evaluation unit of the processing unit in the information processing apparatus according to the embodiment;

FIG. 13 is a diagram illustrating an example of instruction information used for explicit non-response determination processing by the determination unit of the processing unit in the information processing apparatus according to the embodiment;

FIG. 14 is a flowchart illustrating an example of information processing by the processing unit of the information processing apparatus according to the embodiment;

FIG. 15 is a flowchart illustrating an example of request processing by the processing unit of the information processing apparatus according to the embodiment;

FIG. 16 is a flowchart illustrating an example of non-response target information generation processing by the processing unit of the information processing apparatus according to the embodiment; and

FIG. 17 is a hardware configuration diagram illustrating an example of a computer that implements the functions of the information processing apparatus according to the embodiment.

### DETAILED DESCRIPTION OF THE PREFERRED EMBODIMENTS

A mode (hereinafter referred to as “embodiment”) for implementing an information processing apparatus, an information processing method, and a non-transitory computer-readable storage medium according to the present application is explained in detail below with reference to the drawings. Note that the information processing apparatus, the information processing method, and the non-transitory computer-readable storage medium according to the present application are not limited by the embodiment. Embodiments can be combined as appropriate within a range in which processing contents do not contradict each other. In the following embodiments, the same parts are denoted by the same reference numerals and signs and redundant explanation of the parts is omitted.

### [1. Example of Information Processing]

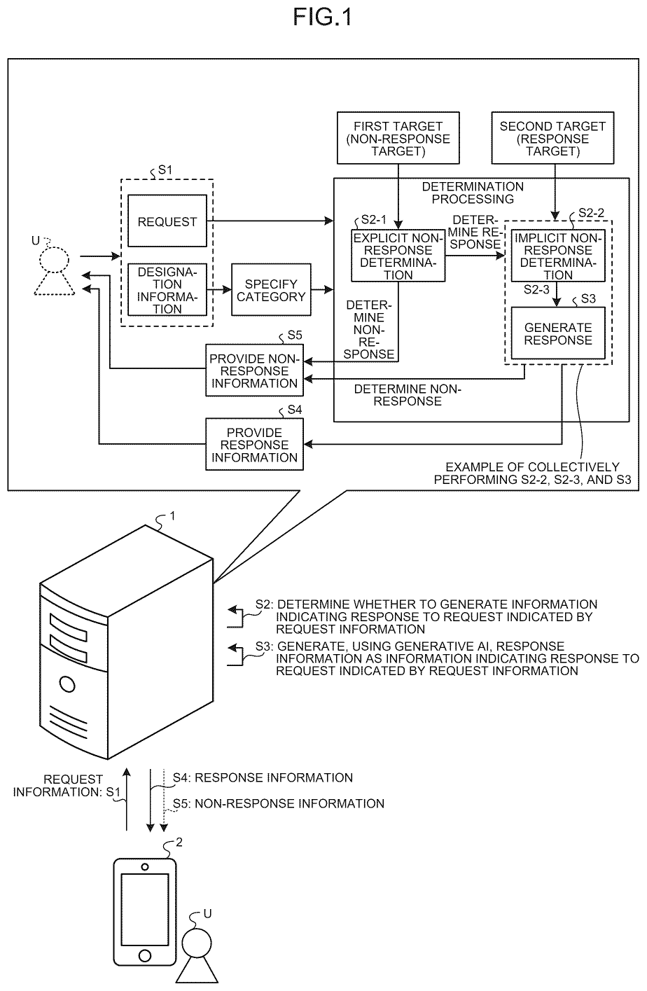

First, an example of information processing according to the embodiment is explained with reference to FIG. 1. FIG. 1 is a diagram for explaining information processing according to an embodiment.

The information processing apparatus 1 illustrated in FIG. 1 is an information processing apparatus that cooperates with terminal devices 2 of a user U and provides various services to the user U online and is implemented by, for example, one or more servers or a cloud system. The terminal device 2 is, for example, a smartphone, a tablet, or a personal computer.

The services provided by the information processing apparatus 1 are various services such as a Q&A (Question and Answer) service such as Yahoo Knowledge Bag, a content creation service, a customer support service, and a learning support service but are not limited to such an example.

In the various services, the information processing apparatus 1 generates response information, which is information indicating a response corresponding to a request of the user U, using generative AI (Artificial Intelligence) and provides the generated response information to the user U.

The generative AI is, for example, text generative AI. The text generative AI is, for example, a large-scale language model learned to estimate the next token from an input token string and output the next token and is, for example, a transformer-based model or a RNN (Recurrent Neural Network)-based model but may be a mixed model thereof or the like. The text generative AI may be a composite system combined with an identification machine or the like for preventing unauthorized use.

The transformer-based model is, for example, a GPT (Generative Pre-trained Transformer) (registered trademark), a PaLM2 (Pathways Language Model Version 2), or LLAMA (Large Language Model Meta AI) but is not limited to such an example. The RNN-based model is, for example, a RWKV (Receptance Weighted Key Value) but is not limited to such an example.

Note that the generative AI is desirably learned not to include personal information and the like in a generation result thereof. The generative AI is disposed in an external information processing apparatus. The information processing apparatus 1 uses the generative AI via an API (Application Programming Interface). However, the generative AI may be disposed in the information processing apparatus 1.

As illustrated in FIG. 1, the information processing apparatus 1 receives request information that is information indicating a request of the user U (step S1). For example, the information processing apparatus 1 receives a use request from the terminal device 2 to thereby receive request information that is information indicating the request of the user U.

The use request includes the request information. The request information includes information such as information indicating a question of the user U, information indicating an instruction of the user U, or information indicating a demand of the user U but is not limited to such an example.

The request information includes designation information for designating a category of the request. For example, when the question of the user U is a question in a Q & A service or a customer support service, the use request includes designation information for designating a category of the question.

When the instruction of the user U is a content creation instruction in a content creation service, the use request includes designation information for designating a category of creation target content. When the instruction of the user U is an instruction of interactive learning in a learning support service, the use request includes designation information for designating a subject as a category of learning.

The designation information is, for example, information indicating the category of the request or information corresponding to the category of the request. The information corresponding to the category of the request is, for example, information of a part or entire URL (Uniform Resource Locator) or a domain name of a category in a service provided by the information processing apparatus 1 but is not limited to such an example.

Subsequently, the information processing apparatus 1 determines whether to generate information indicating a response to the request indicated by the request information received in step S1 (step S2). In the following explanation, it is assumed that the request indicated by the request information received in step S1 is a question in a Q & A service.

For example, the information processing apparatus 1 performs explicit non-response determination processing that is processing of determining whether the request indicated by the request information received in step S1 is a request concerning a first target set as a non-response target (step S2-1). The first target is a target explicitly set as the non-response target.

The non-response target is a target that does not perform a response corresponding to the request indicated by the request information. Although a plurality of first targets are set as non-response targets, one first target may be set. Such a first target is a target explicitly indicated as a non-response target. Therefore, the first target can be considered a determination criterion explicitly indicating the non-response target and can be considered an explicit non-response determination criterion.

The first target, which is an explicit exclusion determination criterion, includes, for example, a target set as a non-response target for a designated category that is a category designated by the user U. The target set as the non-response target for the designated category is, for example, a target depending on the designated category. The information processing apparatus 1 specifies the designated category based on the designation information included in the use request.

The target depending on the designated category is, for example, another category (a category other than the designated category) in which a response is inappropriate in the designated category or another category (a category other than the designated category) in which a boundary with the designated category is ambiguous and a probability of an appropriate response is equal to or smaller than a threshold and is sometimes described as non-response category below. The non-response category is set in advance for each designated category.

The first target set as the non-response target includes, for example, a target that does not depend on the designated category in addition to the target set as the non-response target for the designated category. The target that does not depend on the designated category is, for example, violation of a law, violation of social morals, slander, or defamation but is not limited to such an example.

The target that depends on the designated category and the target that does not depend on the designated category may include a target for which a response using the generative AI is not appropriate. The target for which the response using the generative AI is not appropriate is, for example, medical care, health, or finance but is not limited to such an example.

For example, the information processing apparatus 1 can determine, using a language model, whether the request indicated by the request information is a request concerning a first target set as a non-response target. Such a language model is an example of a first language model and is sometimes described as first language model below. The first language model is a large-scale language model such as a transformer-based model or an RNN-based model but is not limited to such an example.

The information processing apparatus 1 inputs, as input information, to the first language model, information including instruction information for instructing output of information indicating whether the request indicated by the request information included in the use request is a request concerning the first target and information indicating the request included in the request information.

In this case, information indicating whether the request is the request concerning the first target is output from the first language model. As explained above, the information processing apparatus 1 can determine, using the first language model, whether the request indicated by the request information is a request concerning the first target set as the non-response target.

Input information input to AI such as a language model is called prompt. In the following explanation, the input information input to the language model is sometimes described as prompt. The prompt is, for example, information indicating an instruction, a request, or the like given to the AI such as the language model in order to execute a specific task on the AI such as the language model.

For example, when the request indicated by the request information is a question of a specific category (a designated category) in a Q & A service, the instruction information is, for example, information of a character string “You are an excellent filter. Determine whether a given question corresponds to conditions. \n #Condition\n Return “true” when the question corresponds to any one of the following, otherwise, return “false”. Question concerning \n {category1} and question concerning In {category2} question . . . ”. {category1} and {category2} are, for example, information indicating non-response categories set in the designated category.

The instruction information includes information indicating the first target. However, the information indicating the first target may be included in the input information separately from the instruction information. The instruction information may include information indicating the request included in the request information.

The instruction information includes information indicating an output format. The information indicating the output format includes, for example, information output when the request indicated by the request information is a request concerning the first target and information output when the request indicated by the request information is not a request concerning the first target.

The information output when the request indicated by the request information is a request concerning the first target is information indicating non-response determination, for example, “true”. The information output when the request indicated by the request information is not a request concerning the first target is information indicating response determination, for example, “false”. However, the information is not limited to such an example.

The information indicating the output format may be information in a format for outputting specific information only when the request indicated by the request information is a request concerning the first target. In this case, the specific information is information indicating the non-response determination. The specific information not being output is information indicating the response determination. For example, the information indicating the output format is information of a character string “When the request indicated by the request information is a request concerning the first target, output “correspond”, otherwise, output nothing” but is not limited to such an example. The information indicating the output format may be information indicating a sample of output.

In the example explained above, the instruction information is included in the input information input to the first language model. However, the first language model may be a language model learned to output, from the input information not including the instruction information, information indicating whether the request indicated by the request information is a request concerning the first target. The first language model may be a language model learned to output, from the input information not including the instruction information and the information indicating the first target, information indicating whether the request indicated by the request information is a request concerning the first target. In these cases, the language model is generated, for example, for each category but is not limited to such an example.

The information processing apparatus 1 can determine, instead of or in addition to the first language model, with natural language processing not using the first language model, whether the request indicated by the request information is a request concerning the first target set as the non-response target. The natural language processing not using the first language model is, for example, keyword-based natural language processing. The information processing apparatus 1 includes, for example, a first target dictionary including a plurality of keywords each directly or indirectly indicating the first target and determines whether a keyword included in the first target dictionary is included in the request information.

When the keyword included in the first target dictionary is included in the request information, the information processing apparatus 1 determines that the request indicated by the request information is a request concerning the first target set as the non-response target, otherwise, the information processing apparatus 1 determines that the request indicated by the request information is not a request concerning the first target set as the non-response target.

The keyword-based natural language processing may be natural language processing using a model other than the large-scale language model. The model in this case is a model generated by machine learning using learning information including, for each piece of input information, input information and information (label information) indicating whether a request indicated by the input information is a request concerning the first target. Such a model is, for example, a GBDT (Gradient Boosting Decision Tree) or a neural network but is not limited to such an example.

Subsequently, determining in step S2-1 that the request indicated by the request information is not a request concerning the first target, the information processing apparatus 1 performs implicit non-response determination processing that is processing of determining whether the request indicated by the request information is a request concerning the second target set as a response target (step S2-2).

The second target is a target set as a response target. It is determined whether a request is a request concerning the second target to determine whether the second target is not a non-response target. The second target is considered to be a target implicitly indicating the non-response target. Therefore, the second target to be a response target is considered to implicitly indicate a non-response determination criterion and can be referred to as an implicit non-response determination criterion. For example, when there is a category designated by the user U, the second target includes a designated category that is such a category.

For example, the information processing apparatus 1 can determine, using a language model, whether the request indicated by the request information is a request concerning the second target set as the response target. Such a language model is an example of a second language model and is sometimes described as second language model below. The second language model is, for example, a large-scale language model such as a transformer-based model or an RNN-based model but is not limited to such an example. The second language model may be the same language model as the first language model.

The information processing apparatus 1 inputs, to the second language model, as input information, information including instruction information for instructing output of information indicating whether the request indicated by the request information included in the use request is a request concerning the second target and information indicating the request indicated by the request information included in the use request.

In this case, information indicating whether the request is a request concerning the second target is output from the second language model. As explained above, the information processing apparatus 1 can determine, using the second language model, whether the request indicated by the request information is a request concerning the second target set as the response target.

For example, when the request indicated in the request information is a question of a specific category (a designated category) in the Q & A service, the instruction information is, for example, a character string “You are an expert in {category}. Return “true” when the request corresponds to a question concerning {category} or return “false” when the request does not correspond to a question concerning {category}”. {category} is the designated category.

The instruction information includes information indicating the second target. However, the information indicating the second target may be included in the input information separately from the instruction information. The instruction information may include information indicating the request included in the request information.

The instruction information includes information indicating an output format. The information indicating the output format includes, for example, information that is output when the request indicated by the request information is a request concerning the second target and information that is output when the request indicated by the request information is not a request concerning the second target.

The information that is output when the request indicated by the request information is a request concerning the second target is information indicating response determination and is, for example, “true”. The information that is output when the request indicated by the request information is not a request concerning the second target is information indicating non-response determination and is, for example, “false”. However, the information is not limited to such an example.

The information indicating the output format may be information in a format for outputting specific information only when the request indicated by the request information is a request concerning the second target. In this case, the specific information is information indicating the response determination. The specific information being not output is information indicating the non-response determination.

For example, the information indicating the output format is information of a character string “When the request indicated by the request information is a request concerning the second target, output “correspond”, otherwise, output nothing” but is not limited to such an example. The information indicating the output format may be information indicating a sample of output.

In the example explained above, the instruction information is included in the input information input to the second language model. However, the second language model may be a language model learned to output, from the input information not including the instruction information, information indicating whether the request indicated by the request information is a request concerning the second target.

The second language model may be a language model learned to output, from the input information not including the instruction information and the information indicating the second target, information indicating whether the request indicated by the request information is a request concerning the second target. In these cases, the language model is generated, for example, for each category but is not limited to such an example.

The information processing apparatus 1 can determine, instead of or in addition to the second language model, with natural language processing not using the second language model, whether the request indicated by the request information is a request concerning the second target set as the response target.

The natural language processing not using the second language model is, for example, keyword-based natural language processing. The information processing apparatus 1 includes, for example, a second target dictionary including a plurality of keywords each directly or indirectly indicating the second target and determines whether a keyword included in the second target dictionary is included in the request information.

When the keyword included in the second target dictionary is included in the request information, the information processing apparatus 1 determines that the request indicated by the request information is the request concerning the second target set as the response target, otherwise, the information processing apparatus 1 determines that the request indicated by the request information is not the request concerning the second target set as the response target.

The keyword-based natural language processing may be natural language processing using a model other than the large-scale language model. The model in this case is a model generated by machine learning using learning information including, for each piece of input information, input information and information (label information) indicating whether a request indicated by the input information is a request concerning the second target. Such a model is, for example, GBDT or a neural network but is not limited to such an example.

Subsequently, the information processing apparatus 1 determines, based on a determination result as to whether the request indicated by the request information is a request concerning the second target in step S2-2, whether to generate response information that is information indicating a response to the request indicated by the request information received in step S1 (step S2-3).

For example, when determining in step S2-2 that the request indicated by the request information is a request concerning the second target, the information processing apparatus 1 determines to generate information indicating a response to the request indicated by the request information.

Furthermore, when determining in step S2-2 that the request indicated by the request information is not a request concerning the second target, the information processing apparatus 1 determines not to generate information indicating a response to the request indicated by the request information.

As explained above, the information processing apparatus 1 first performs the explicit non-response determination processing, performs the implicit non-response determination processing when the explicit non-response determination criterion is not satisfied, and performs a response when the implicit non-response determination criterion is not satisfied. Accordingly, the information processing apparatus 1 can perform highly accurate response propriety determination at low cost and can suppress inappropriate responses.

Note that the information processing apparatus 1 can perform the explicit non-response determination processing and the implicit non-response determination processing in parallel. In this case, the information processing apparatus 1 determines, based on the determination result of the explicit non-response determination processing and the determination result of the implicit non-response determination processing, whether to generate information indicating a response to the request indicated by the request information.

In this case, the information processing apparatus 1 determines to generate the information indicating the response to the request indicated by the request information when the request indicated by the request information is not the request concerning the first target and the request indicated by the request information is the request concerning the second target, otherwise, determines not to generate the information indicating the response to the request indicated by the request information. This also enables the information processing apparatus 1 to suppress an inappropriate response.

The information processing apparatus 1 can also perform processing in the order of the implicit non-response determination processing and the explicit non-response determination processing. In this case, the explicit non-response determination processing can also be performed only when it is determined in the implicit non-response determination processing that the request indicated by the request information is a request concerning the second target. This also enables the information processing apparatus 1 to suppress an inappropriate response.

As explained above, the information processing apparatus 1 can determine, based on whether the request indicated by the request information is a request concerning the first target set as the non-response target and a request concerning the second target set as the response target, whether to generate the information indicating the response to the request indicated by the request information.

Subsequently, when determining in step S2 to generate information indicating the response to the request indicated by the request information, the information processing apparatus 1 generates response information using the generative AI as the information indicating the response to the request indicated by the request information (step S3).

For example, the information processing apparatus 1 inputs, to the generative AI, as input information, information including instruction information for instructing output of information indicating a response to the request indicated by the request information and information indicating the request included in the request information and causes the generative AI to generate the response information.

The request indicated by the request information is, for example, a question of an economic category in the Q & A service and is information of a character string “What is inflation? How does it affect the economy?”. In this case, the information processing apparatus 1 inputs, to the generative AI, as the input information, information including the information of the character string “As an expert in {category}, you receive and answer questions concerning {category}” as the instruction information and information including the information of the character string “What is inflation? How does it affect the economy?” as the information indicating the request included in the request information.

Note that {category} includes information indicating the designated category. The instruction information may include guideline information indicating a guideline for an answer. The guideline information includes information indicating, for example, clarity and neutrality of the answer.

In the example explained above, an example is explained in which the processing in step S2 and the processing in step S3 are separately performed. However, a part or the entire processing in step S2 may be included in the processing in step S3.

For example, when determining in step S2-1 that the request indicated by the request information is not a request concerning the first target, by inputting, to the generative AI, as the input information, information including instruction information for instructing generation of information indicating a response to the request indicated by the request information when the request is a request concerning the second target, the information processing apparatus 1 can collectively perform the processing in step S2-2, step S2-3, and step S3 as in processing described in a balloon in FIG. 1. In this case, the second language model explained above is the generative AI and the processing in step S2-2, step S2-3, and step S3 can be collectively performed by inputting the input information (the prompt) to the generative AI once.

In this case, the instruction information included in the input information is, for example, information of a character string “#You are an expert of {category} and receive and answer a question or consultation concerning {category}. Do not answer questions other than the {category} category”. However, the instruction information is not limited to such an example. Note that {category} includes information indicating the designated category. The instruction information may include guideline information.

Furthermore, When the request indicated by the request information is not a request concerning the first target but a request concerning the second target, by inputting, to the generative AI, as input information, information including instruction information for instructing generation of information indicating a response to the request indicated by the request information, the information processing apparatus 1 can collectively perform the processing in steps S2 and S3. In this case, the first language model and the second language model explained above are the generative AI and the processing in steps S2 and S3 can be collectively performed by inputting input information (a prompt) once to the generative AI.

In this case, the instruction information included in the input information is, for example, information of the character string “#You are an excellent AI assistant. Determine to which one of {category group} a given question corresponds and, when the given question does not correspond to all of {category group}, as an expert in {category}, you receive and answer questions concerning {category}. Do not answer questions other than the {category} category”. However, the instruction information is not limited to such an example. Note that {category group} includes information indicating one or more first targets and {category} includes information indicating a designated category. The instruction information may include guideline information.

Subsequently, when the response information is generated using the generative AI in step S3, the information processing apparatus 1 provides the response information generated using the generative AI to the user U (step S4). For example, the information processing apparatus 1 transmits the response information generated using the generative AI in step S3 to the terminal device 2, which has transmitted the use request, to provide the response information generated using the generative AI to the user U.

For example, when the request indicated by the request information is a Q & A service question and the user U accesses a page indicating an answer to a question of the user U, the information processing apparatus 1 can provide the page indicating the answer to the question of the user U to the user U.

When the response information is not generated using the generative AI in step S3, the information processing apparatus 1 provides non-response information to the user U (step S5). For example, when determining in step S2-1 that the request indicated by the request information is a request concerning the first target or when determining in step S2-2 that the request indicated by the request information is not a request concerning the second target, the information processing apparatus 1 provides the non-response information to the user U.

The non-response information is, for example, information of character information “Sorry. The target is a non-response target and we cannot respond to the request”. For example, when the request indicated by the request information is a request of a Q & A service, the non-response information is, for example, information of character information “Sorry. We cannot answer the question because the question is a question not to be answered”. Note that the non-response information may include information clearly indicating that the request is a request concerning the first target or is not a request concerning the second target.

In the explicit non-response determination criterion explained above, by including, in addition to the fixed first target that does not depend on the designated category, as the first target that depends on the designated category, a category that is a category other than the designated category and is set in advance for each designated category it is possible to improve non-response accuracy for an inappropriate request.

On the other hand, the first target explained above depending on the designated category is a non-response category that is a category set in advance as a non-response category for each designated category and is a category other than the designated category and is, for example, an abstract concept. Therefore, non-response coverage is low and it is likely that the information processing apparatus 1 cannot reject an inappropriate request.

For example, it is likely that the information processing apparatus 1 cannot reject requests that should not be responded such as a request against social morals and a request for a response that becomes defamation in the non-response category and a request for which a response using the generative AI is inappropriate in the non-response category. The request for which the response using the generative AI is inappropriate is, for example, a request including topics such as medical, health, and financial topics in the non-response category but is not limited to such an example.

Therefore, the information processing apparatus 1 is configured to be able to perform, based on non-response category information indicating the non-response category correlated with the designated category, generation processing of generating non-response target information indicating a new non-response target. Accordingly, it is possible to further improve the non-response accuracy for an inappropriate request. The generation processing executed by the information processing apparatus 1 is specifically explained below.

The generation processing executed by the information processing apparatus 1 includes first generation processing of generating, from non-response category information that is information indicating a non-response category, as new non-response target information, risk information that is information indicating a risk and second generation processing of extracting feature words from the non-response category information and generating new non-response target information from the extracted feature words.

First, the first generation processing is explained. In the first generation processing, for example, the information processing apparatus 1 generates new non-response target information using a language model. Such a language model is an example of a third language model and is sometimes described as third language model below. The third language model is, for example, a large-scale language model such as a transformer-based model or an RNN-based model. The third language model may be the same as one or more of the generative AI, the first language model, and the second language model explained above.

For example, the information processing apparatus 1 generates, from the non-response category information, as new non-response target information, using the third language model, risk information that is information indicating a risk in the non-response category. For example, the information processing apparatus 1 can input information including the non-response category information to the third language model as input information and cause the third language model to generate and output, as new non-response target information, risk information that is information indicating a risk in the non-response category. In the following explanation, the information indicating a risk is sometimes described as risk information.

For example, the information processing apparatus 1 inputs, to the third language model, as input information, information including instruction information for instructing output of risks in one or more non-response categories and causes the third language model to generate and output risk information in the non-response category. For example, when non-response categories are adult, gamble, and the like, the instruction information includes information of a character string “Output conceivable risks based on given category information. \n #category information\n adult\n gamble”.

The third language model may be, for example, a model learned to output non-response target information when information including the non-response category information is input as input information. In this case, the third language model is learned using, for example, learning information including, for each non-response category, the information including the non-response category information and one or more pieces of non-response target information. The one or more pieces of non-response target information are used as teacher data (labels).

The information processing apparatus 1 can generate, for example, one or more pieces of risk information for each non-response category using the third language model. The information processing apparatus 1 can also include, in the designation information, information for designating the number of pieces of non-response category information that the information processing apparatus 1 causes the third language model to generate.

For example, the information processing apparatus 1 can also cause the third language model to generate, as risk information, information indicating risks conceivable for an administrator of a service that performs a response corresponding to a request for the designated category.

For example, it is assumed that the request indicated by the request information is a question of a Q & A service, the designated category is television, and non-response categories are adult and gamble. In this case, the instruction information included in the input information includes information of a character string “You are an administrator who answers a question concerning television in the Q & A service. Please output conceivable risks based on the given category information”.

In addition, when the information processing apparatus 1 has obtained a plurality of pieces of risk information using the third language model, the information processing apparatus 1 aggregates, using the third language model, the plurality of pieces of risk information into a preset number n or less pieces of risk information as non-response target information. n is an integer equal to or larger than 1. For example, the information processing apparatus 1 can input information including instruction information for grouping the plurality of pieces of risk information into n pieces of risk information to the third language model as input information and cause the third language model to output the aggregated n pieces of risk information.

For example, when the information processing apparatus 1 causes the third language model to generate, as risk information, information indicating risks conceivable for an administrator of the Q & A service explained above, for example, by inputting, to the third language model, as input information, instruction information including information of a character string “You are an administrator who answers a question concerning television in the Q & A service. Please aggregate, based on given risk information, risks that have to be regarded as important in continuing the service into five risks” and a plurality of pieces of risk information, the information processing apparatus 1 can cause the third language model to output aggregated n pieces of risk information.

Subsequently, the second generation processing is explained. In the second generation processing, the information processing apparatus 1 extracts feature words (for example, keywords or characteristic phrases) from the non-response category information and generates new non-response target information from the extracted feature words.

The information processing apparatus 1 divides the non-response category information to extract feature words and generates new non-response target information using the feature words. For example, the information processing apparatus 1 can perform, using the third language model, processing of extracting feature words from the non-response category information and generating information partially including each of the feature words as a plurality of pieces of new non-response target information.

For example, it is assumed that the request indicated by the request information is a question in the Q & A service and the non-response category information is a character string “question concerning the Internet”. In this case, for example, by inputting, to the third language model, information of a character string “#Instruction Please extract feature words, which are important words, from given keywords and create subdivided keyword. “\n\n #keyword\n question about the Internet”, the information processing apparatus 1 can cause the third language model to generate a plurality of pieces of new non-response target information. The plurality of pieces of new non-response target information in this case are, for example, information of a character string “Internet technology” and information of a character string “Internet service” but are not limited to such an example.

For example, the information processing apparatus 1 can also generate a plurality of pieces of new non-response target information on a rule basis instead of using the third language model. For example, the information processing apparatus 1 includes a feature word dictionary including a plurality of keywords or phrases for each feature word and can extract, as a plurality of pieces of new non-response target information, a plurality of keywords or phrases correlated with feature words included in the feature word dictionary among the non-response category information.

When there are a plurality of pieces of non-response category information, the information processing apparatus 1 can perform, for each non-response category, processing of generating a plurality of pieces of non-response target information using the third language model but can also collectively perform, in a plurality of non-response categories, processing of generating a plurality of pieces of non-response target information using the third language model.

Based on the non-response accuracy for each combination of two or more pieces of non-response target information among the plurality of pieces of non-response category information generated as explained above, the information processing apparatus 1 can select two or more pieces of non-response target information to be used in step S2-1 among the plurality of pieces of non-response target information generated as explained above. In this case, the information processing apparatus 1 determines whether the request indicated by the request information is a request concerning a non-response target in step S2-1 based on the selected two or more pieces of response target information.

For example, the information processing apparatus 1 can evaluate the non-response accuracy for each combination of two or more pieces of non-response target information. For example, the information processing apparatus 1 can evaluate the non-response accuracy for each combination of two or more pieces of response target information using a plurality of pieces of evaluation request information. In the following explanation, a combination of two or more pieces of non-response target information is sometimes described as non-response target information combination.

The pieces of evaluation request information are information indicating a first request that is a request concerning the non-response target in the designated category, information indicating a second request that is a request concerning the response target in the designated category, or information indicating a third request that is a request concerning the non-response target regardless of the designated category.

The information processing apparatus 1 determines whether the request indicated by the evaluation request information is determined to be a request concerning a non-response target in explicit non-response determination processing using the non-response target information combination. The explicit non-response determination processing using the non-response target information combination is, for example, processing of using each of the plurality of pieces of non-response target information included in the non-response target information combination as the first target.

When determining that the first request or the third request indicated by the evaluation request information is a request concerning a non-response target in the explicit non-response determination processing using the non-response target information combination, the information processing apparatus 1 evaluates the non-response target information combination as 1, otherwise, evaluates the non-response target information combination as 0.

Furthermore, in a case in which the information processing apparatus 1 determines that the second request indicated by the evaluation request information is not a request concerning a non-response target in the explicit non-response determination processing using the prompt including the non-response target information combination, the information processing apparatus 1 sets the evaluation of the non-response target information combination to 1, otherwise, sets the evaluation of the non-response target information combination to 0.

The information processing apparatus 1 can calculate non-response accuracy by aggregating an evaluation result and dividing the aggregation result by the number of evaluations. The information processing apparatus 1 can change weight depending on whether the request indicated by the evaluation request information is the first request, the second request, or the third request and aggregate the evaluation result by weighted addition.

Further, the evaluation request information may be limited to information indicating the first request or may be limited to two or more pieces of information among information indicating the first request, information indicating the second request, and information indicating the third request. The evaluation is not limited to 0 and 1 and may be, for example, −1 and 1 or may be a combination of other values.

The information processing apparatus 1 can evaluate the non-response accuracy of the non-response target information combination using a language model even when it is determined, using the keyword-based natural language processing, for example, whether requests indicated by request information from the users U are requests concerning the non-response target in the explicit non-response determination processing using the non-response target information combination.

For example, the information processing apparatus 1 can evaluate the non-response accuracy of the non-response target information combination for each non-response target information combination using the third language model based on information indicating the request included in the request information from the users U and a determination result of the keyword-based natural language processing.

For example, the information processing apparatus 1 inputs, to the third language model, as input information, information including instruction information for instructing determination as to whether any of the two or more pieces of non-response target information indicated by the non-response target information combination is not included in the request information from the user U to cause the third language model to output information indicating non-response accuracy of the two or more pieces of response target information indicated by the non-response target information combination.

The information processing apparatus 1 selects a non-response target information combination having the highest non-response accuracy among non-response accuracies for each non-response target information combination as the non-response target information combination used in step S2-1.

The information processing apparatus 1 can also select, at random or according to a predetermined rule, a non-response target information combination having non-response accuracy equal to or larger than a threshold for each non-response target information combination as a combination of two or more pieces of non-response target information to be used in step S2-1.

As explained above, the information processing apparatus 1 according to the embodiment receives information indicating a request of the user U, determines whether to generate the information indicating a response to the request indicated by the received information, and, when determining to generate the information indicating the response, provides, to the user U, response information generated using the generative AI as the information indicating the response to the request. The information processing apparatus 1 determines, based on whether the request indicated by the received information is a request concerning the first target set as the non-response target and a request concerning the second target set as the response target, whether to generate information indicating a response to the request indicated by the received information. Accordingly, the information processing apparatus 1 can suppress an inappropriate response.

The information processing apparatus 1 according to the embodiment generates non-response target information indicating the non-response target, receives information indicating a request of the user U, and determines, based on a generated plurality of pieces of non-response target information, whether the request indicated by the received information is a request concerning the non-response target. Accordingly, the information processing apparatus 1 can suppress an inappropriate response.

A configuration and the like of an information processing system including the information processing apparatus 1 and the terminal device 2 that perform such processing is explained in detail below.

### [2. Configuration of the Information Processing System]

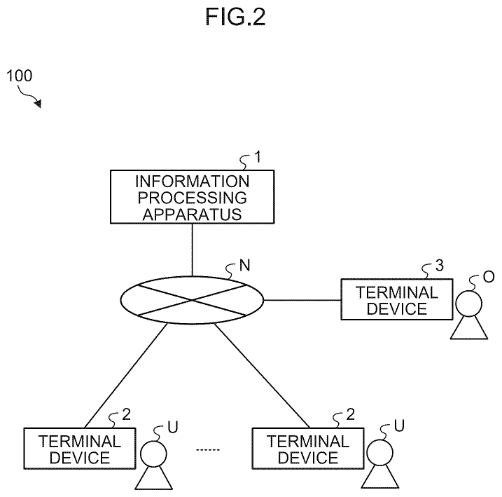

FIG. 2 is a diagram illustrating an example of a configuration of an information processing system according to the embodiment. As illustrated in FIG. 2, an information processing system 100 according to the embodiment includes the information processing apparatus 1, a plurality of terminal devices 2, and a terminal device 3.

The plurality of terminal devices 2 are used by different users U. The terminal device 3 is used by, for example, an employee O of an operating company of the information processing apparatus 1. The terminal devices 2 and 3 are, for example, a notebook PC (Personal Computer), a desktop PC, a smartphone, a tablet PC, and a wearable device. The wearable device is, for example, a smart glass, a smart watch, or the like but is not limited to such an example.

Each of the information processing apparatus 1, the terminal device 2, and the terminal device 3 is communicably connected to one another by wire or radio via a network N. Note that the information processing system 100 illustrated in FIG. 2 may include a plurality of information processing apparatuses 1.

The network N includes, for example, a WAN (Wide Area Network) such as the Internet and a mobile communication network such as LTE (Long Term Evolution), 4G (4th Generation), or 5G (5th Generation: a fifth generation mobile communication system) but is not limited to such an example.

The terminal devices 2 and 3 can be connected to the network N via short-range wireless communication such as a mobile communication network, Bluetooth (registered trademark), or a wireless local area network (LAN) and can communicate with the information processing apparatus 1 or the like.

### [3. Configuration of the Information Processing Apparatus 1]

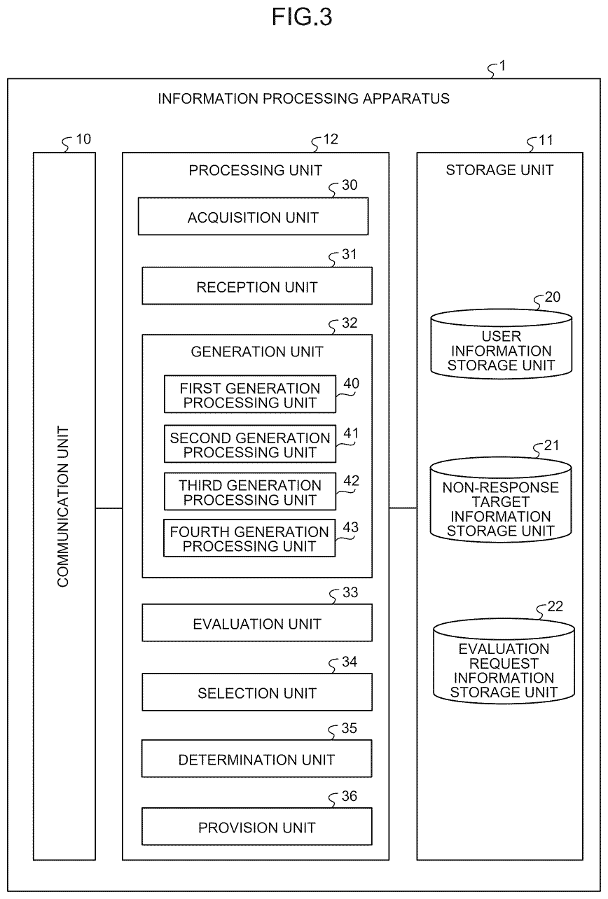

FIG. 3 is a diagram illustrating an example of a configuration of the information processing apparatus 1 according to the embodiment. As illustrated in FIG. 3, the information processing apparatus 1 includes a communication unit 10, a storage unit 11, and a processing unit 12.

### [3.1. Communication Unit 10]

The communication unit 10 is implemented by, for example, a communication module or an NIC (Network Interface Card). Then, the communication unit 10 is connected to the network N by wire or radio and transmits and receives information to and from various other devices. For example, the communication unit 10 transmits and receives information to and from each of the terminal device 2 and the terminal device 3 via the network N.

### [3.2. Storage Unit 11]

The storage unit 11 is implemented by, for example, a semiconductor memory element such as a RAM (Random Access Memory) or a flash memory or a storage device such as a hard disk or an optical disk. The storage unit 11 includes a user information storage unit 20, a non-response target information storage unit 21, and an evaluation request information storage unit 22.

### [3.2.1. User Information Storage Unit 20]

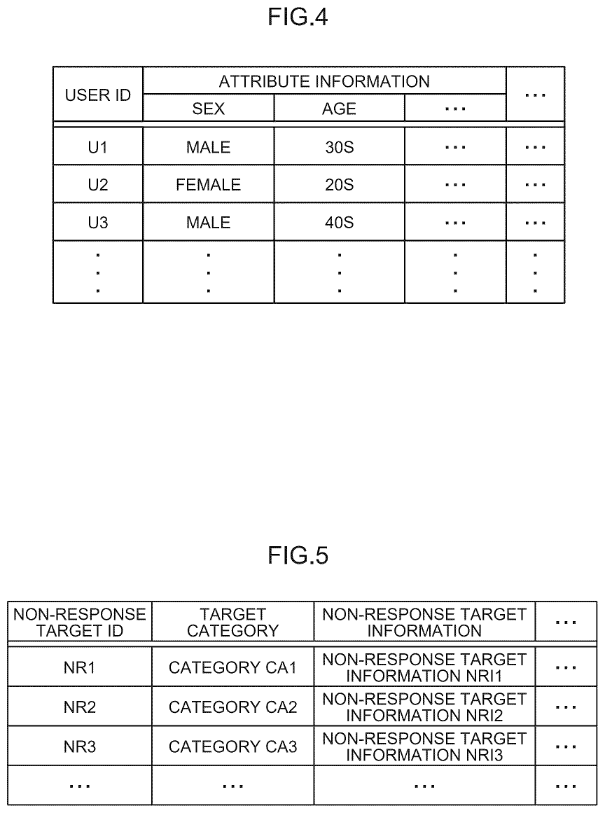

The user information storage unit 20 stores user information including information on the user U. FIG. 4 is a diagram illustrating an example of a user information table stored in the user information storage unit 20 of the information processing apparatus 1 according to the embodiment. As illustrated in FIG. 4, the user information table stored in the user information storage unit 20 includes items such as “user ID” and “attribute information”.

The “user ID” is identification information for identifying the user U. The “attribute information” is attribute information of the user U corresponding to the “user ID” and includes, for example, information of a psychographic attribute and information of a demographic attribute. The demographic attribute is, for example, gender, age, a place of residence, and an occupation and the psychographic attribute is an object of interest such as travel, clothes, cars, and religion, a lifestyle, an idea and a tendency of the idea, and the like.

### [3.2.2. Non-Response Target Information Storage Unit 21]

The non-response target information storage unit 21 stores information indicating various non-response targets. FIG. 5 is a diagram illustrating an example of a non-response target table stored in the non-response target information storage unit 21 of the information processing apparatus 1 according to the embodiment.

In the example illustrated in FIG. 5, the non-response target table stored in the non-response target information storage unit 21 includes information of items such as “non-response target ID”, “target category”, and “non-response target information”. The “non-response target ID” is an identifier for identifying a non-response target and is information attached to each non-response target. The non-response target includes the first target explained above.

The “target category” is information indicating a category correlated with the non-response target and is set to blank (null) when there is no category correlated with the non-response target. The “non-response target information” is information indicating a non-response target and is, for example, non-response category information indicating a non-response category correlated in advance by the employee O or the like as a non-response category for the target category and non-response target information generated by the processing unit 12 but is not limited to such an example.

### [3.2.3. Evaluation Request Information Storage Unit 22]

The evaluation request information storage unit 22 stores various pieces of evaluation request information. The evaluation request information is, for example, information indicating a first request that is a request concerning a non-response target in a designated category, information indicating a second request that is a request concerning a response target in the designated category, or information indicating a third request that is a request concerning the non-response target regardless of the designated category.

### [3.3. Processing Unit 12]

The processing unit 12 is a controller and is implemented by, for example, a processor such as a CPU (Central Processing Unit) or an MPU (Micro Processing Unit) executing various programs (corresponding to an example of an information processing program) stored in a storage device inside the information processing apparatus 1 using a RAM or the like as a work area.

The processing unit 12 is a controller and a part or the entire processing unit 12 may be implemented by an integrated circuit such as an ASIC (Application Specific Integrated Circuit), an FPGA (Field Programmable Gate Array), or a GPGPU (General Purpose Graphic Processing Unit).

As illustrated in FIG. 3, the processing unit 12 includes an acquisition unit 30, a reception unit 31, a generation unit 32, an evaluation unit 33, a selection unit 34, a determination unit 35, and a provision unit 36 and implements or executes a function and action of information processing explained below. Note that an internal configuration of the processing unit 12 is not limited to the configuration illustrated in FIG. 3 and may be another configuration if the configuration is a configuration for performing information processing explained below.

### [3.3.1. Acquisition Unit 30]

The acquisition unit 30 acquires various kinds of information from an external information processing apparatus, the terminal devices 2 and 3, or the like via the network N and the communication unit 10.

For example, the acquisition unit 30 acquires information concerning the user U from the external information processing apparatus or the terminal device 2 and stores the acquired information concerning the user U in the user information storage unit 20. The acquisition unit 30 acquires non-response category information from the external information processing apparatus or terminal device 3 and stores the acquired non-response category information in the non-response target information storage unit 21. The acquisition unit 30 acquires evaluation request information from the external information processing apparatus or the terminal device 3 and stores the acquired evaluation request information in the evaluation request information storage unit 22.

The acquisition unit 30 acquires various kinds of information from the storage unit 11. For example, the acquisition unit 30 acquires the information concerning the user U from the user information storage unit 20. The acquisition unit 30 acquires non-response target information corresponding to the designated category from the non-response target information storage unit 21. The acquisition unit 30 acquires the evaluation request information from the evaluation request information storage unit 22.

### [3.3.2. Reception Unit 31]

The reception unit 31 receives various requests and information. For example, the reception unit 31 receives request information that is information indicating a request of the user U. For example, the reception unit 31 receives a use request to thereby receive request information included in the use request. The request information includes information such as information indicating a question of the user U, information indicating an instruction of the user U, or information indicating a demand of the user U but is not limited to such an example.

The request information includes designation information for designating a category of the request. The reception unit 31 specifies a designated category based on the designation information included in the received use request. For example, when the question of the user U is a question in a Q & A service or a customer support service, the use request includes designation information for designating a category of the question.

When the instruction of the user U is a content creation instruction in a content creation service, the use request includes designation information for designating a category of creation target content. When the instruction of the user U is an instruction of interactive learning in a learning support service, the use request includes designation information for designating a subject as a category of learning.

The designation information is, for example, information indicating the category of the request or information corresponding to the category of the request. The information corresponding to the category of the request is, for example, a part or an entire URL or a domain name of a category in a service provided by the information processing apparatus 1 but is not limited to such an example.

### [3.3.3. Generation Unit 32]

The generation unit 32 generates various kinds of information. For example, the generation unit 32 generates non-response target information as information indicating the first target. The non-response target information is information indicating a non-response target that is a target not responding to the request indicated by the request information received by the reception unit 31.

The generation unit 32 generates non-response target information indicating a new non-response target. For example, the generation unit 32 generates, based on non-response category information indicating a non-response category, which is a category different from a designated category that is a category designated by the user U, and is correlated with the designated category in advance as a non-response category, non-response target information indicating a new non-response target.

For example, the generation unit 32 can generate, from the non-response category information indicating the non-response category, as new non-response target information, risk information that is information indicating a risk. The generation unit 32 can extract feature words from the non-response category information and generate new non-response target information from the extracted feature words. For example, the generation unit 32 generates, as the non-response target information, information partially including the feature words extracted from the non-response category information.

For example, the generation unit 32 generates the non-response target information as the information indicating the first target using the third language model. For example, the generation unit 32 inputs information including the non-response category information indicating the non-response category to the third language model and causes the third language model to generate the non-response target information.

When the determination unit 35 determines to generate the information indicating the response to the request indicated by the request information received by the reception unit 31, the generation unit 32 generates response information using the generative AI as the information indicating the response to the request indicated by the request information received by the reception unit 31.

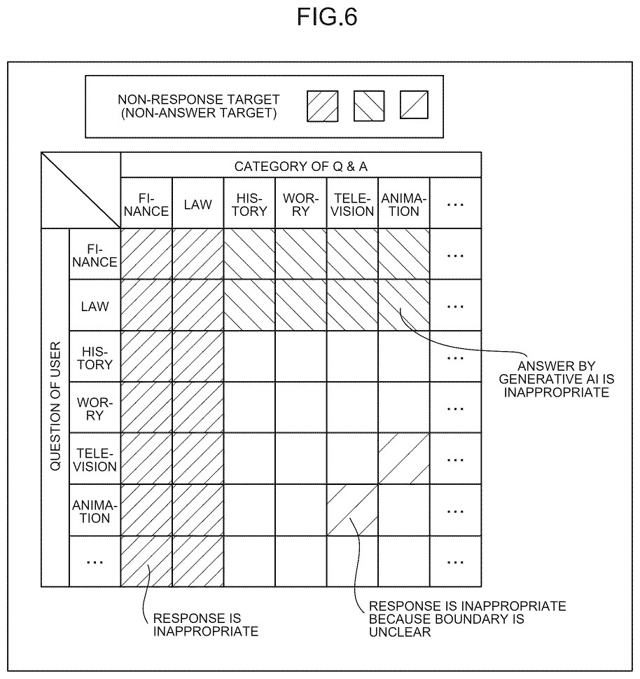

FIG. 6 is a diagram illustrating an example of non-response categories set in advance in categories in the information processing apparatus 1 according to the embodiment. The example illustrated in FIG. 6 indicates an example of non-response categories set in advance for the categories when the request indicated by the request information is a question of a Q & A service. Financial and legal categories are set as the non-response categories regardless of a category of a question of the user U.

In the example illustrated in FIG. 6, when a category of a question of the user U is finance or law, all categories other than the category are set as non-response categories, when the category of the question of the user U is television, animation is set as a non-response category, and, when the category of the question of the user U is animation, television is set as a non-response category. Note that non-response categories set in advance for the categories are not limited to the example illustrated in FIG. 6.

As illustrated in FIG. 3, the generation unit 32 includes a first generation processing unit 40 that generates a plurality of pieces of risk information indicating risks in the non-response categories and a second generation processing unit 41 that aggregates the plurality of pieces of risk information generated by the first generation processing unit 40 into n pieces of risk information. The generation unit 32 includes a third generation processing unit 42 that generates, as new non-response target information, information partially including feature words extracted from the non-response category information and a fourth generation processing unit 43 that causes the generative AI to generate response information that is information indicating a response to the request indicated by the request information.

### [3.3.3.1. First Generation Processing Unit 40]

The first generation processing unit 40 generates risk information indicating a risk in a non-response category using the third language model. The third language model is, for example, a large-scale language model such as a transformer-based model or an RNN-based model. The third language model may be the same as one or more of the generative AI, the first language model, and the second language model explained above.

For example, the first generation processing unit 40 generates, from the non-response category information, as new non-response target information, using the third language model, risk information that is information indicating a risk in the non-response category. For example, the first generation processing unit 40 can input information including the non-response category information to the third language model as input information and cause the third language model to generate and output, as new non-response target information, risk information that is information indicating a risk in the non-response category.

For example, the first generation processing unit 40 inputs information including instruction information for instructing output of risks in one or more non-response categories to the third language model as input information and causes the third language model to generate and output risk information of the non-response category.

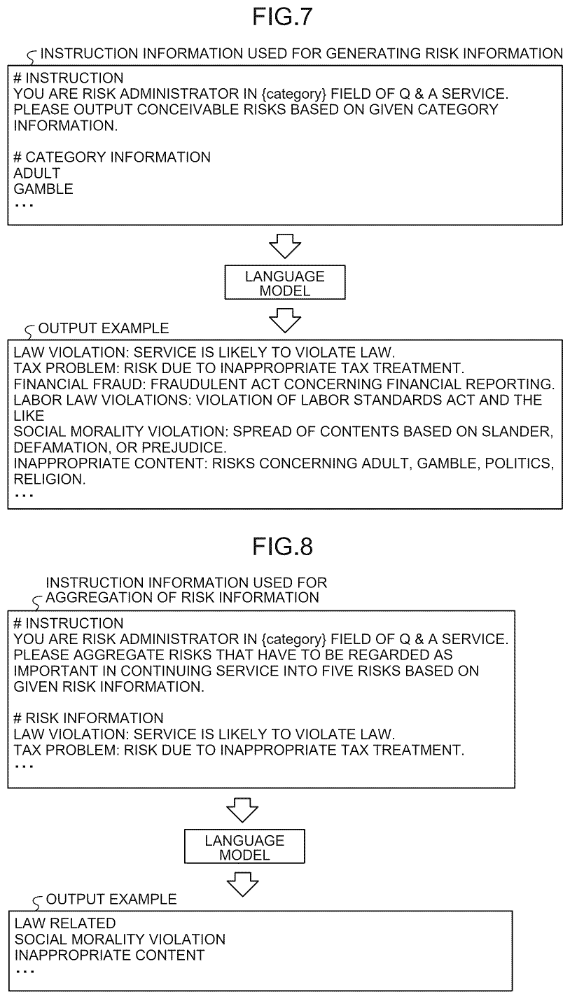

FIG. 7 is a diagram illustrating an example of instruction information used by the first generation processing unit 40 in the processing unit 12 of the information processing apparatus 1 according to the embodiment and an output example of the third language model. In FIG. 7, for example, when non-response categories are adult and gamble, the instruction information includes information of a character string “#Instruction \n You are a risk administrator in a {category} field of a Q & A service. \n Please output conceivable risks based on given category information. \n\n #category information\n adult\n gamble . . . ”. In FIG. 7, {category} is information indicating a designated category.

As illustrated in FIG. 7, the first generation processing unit 40 can cause the third language model to generate, as risk information, information indicating risks conceivable for an administrator of a service that performs a response corresponding to a request for the designated category.

The third language model may be, for example, a model learned to output non-response target information when information including the non-response category information is input as input information. In this case, the third language model is learned using, for example, learning information including, for each non-response category, the information including the non-response category information and one or more pieces of non-response target information. The one or more pieces of non-response target information are used as teacher data (labels).

The first generation processing unit 40 can generate, for example, one or more pieces of risk information for each non-response category using the third language model. The first generation processing unit 40 can also include, in the designation information, information for designating the number of pieces of non-response category information that the first generation processing unit 40 causes the third language model to generate.

### [3.3.3.2. Second Generation Processing Unit 41]

The second generation processing unit 41 aggregates a plurality of pieces of risk information generated by the first generation processing unit 40 into a preset number n or less of risk information as non-response target information using a language model. n is an integer equal to or larger than 1.

For example, when more than n pieces of risk information are generated by the first generation processing unit 40, the second generation processing unit 41 aggregates the plurality of pieces of risk information generated by the first generation processing unit 40 into a preset number n or less pieces of risk information as non-response target information using the third language model.

For example, the second generation processing unit 41 can input information including instruction information for grouping the plurality of pieces of risk information generated by the first generation processing unit 40 into n pieces of risk information to the third language model as input information, and output the n pieces of risk information aggregated in the third language model.

FIG. 8 is a diagram illustrating an example of instruction information used by the second generation processing unit 41 in the processing unit 12 of the information processing apparatus 1 according to the embodiment and an output example of the third language model. In FIG. 8, the instruction information is information of the character string “#Instruction \n You are a risk administrator in a {category} field of a Q & A service. \n Please aggregate, based on given risk information, risks that have to be regarded as important in continuing the service into five risks. \n\n #Risk information\n violation of law: the service is likely to violate the law. \n Tax Problem: Risk due to inappropriate tax treatment . . . ”. By inputting, to the third language model, as input information, information including the instruction information and information indicating a request included in request information, it is possible to cause the third language model to output aggregated n pieces of risk information.

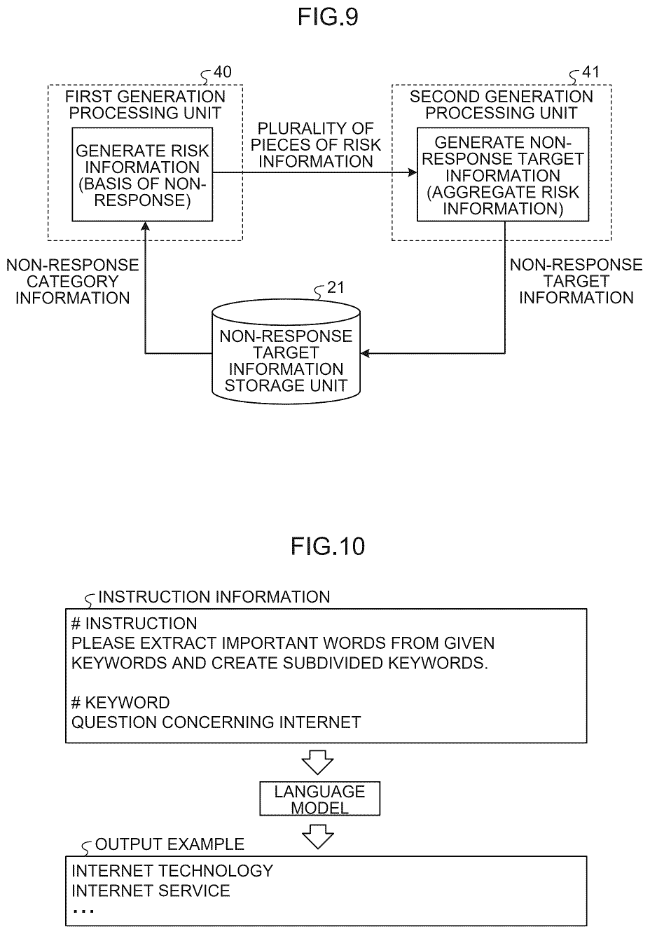

FIG. 9 is a diagram illustrating a relationship of processing by the first generation processing unit 40 and the second generation processing unit 41 in the processing unit 12 of the information processing apparatus 1 according to the embodiment. As illustrated in FIG. 9, the first generation processing unit 40 generates a plurality of pieces of risk information based on the non-response category information stored in the non-response target information storage unit 21. The second generation processing unit 41 aggregates the plurality of pieces of risk information generated by the first generation processing unit 40 into n pieces of risk information and stores an aggregation result in the non-response target information storage unit 21 as n pieces of non-response target information.

### [3.3.3.3. Third Generation Processing Unit 42]

The third generation processing unit 42 generates, as new non-response target information, information partially including feature words (for example, keywords or characteristic phrases) extracted from the non-response category information.

For example, the third generation processing unit 42 divides the non-response category information to extract feature words and generates new non-response target information using the feature words. For example, the third generation processing unit 42 can perform processing of extracting feature words from the non-response category information and generating information partially including the feature words as a plurality of pieces of new non-response target information using the third language model.

FIG. 10 is a diagram illustrating an example of instruction information and an output example of the third language model used by the third generation processing unit 42 in the processing unit 12 of the information processing apparatus 1 according to the embodiment and is an example in the case in which a request indicated by request information is a question in a Q & A service and non-response category information is a character string “question concerning the Internet”.

In this case, as illustrated in FIG. 10, for example, by inputting, to the third language model, information of a character string “#Instruction \n Please extract important words from given keywords and create subdivided keywords. \n\n #Keyword\n question about the Internet”, the third generation processing unit 42 can cause the third language model to generate a plurality of pieces of new non-response target information. As illustrated in FIG. 9, the plurality of pieces of new non-response target information in this case are, for example, information of a character string “Internet technology” and information of a character string “Internet service” but are not limited to such an example.

For example, the third generation processing unit 42 can generate a plurality of pieces of new non-response target information on a rule basis instead of using the third language model. For example, the third generation processing unit 42 has a feature word dictionary including a plurality of keywords or phrases for each feature word and can extract, as a plurality of pieces of new non-response target information, a plurality of keywords or phrases correlated with feature words included in a feature word dictionary among the non-response category information.

When there are a plurality of pieces of non-response category information, the third generation processing unit 42 can perform, for each non-response category, processing of generating a plurality of pieces of non-response target information using the third language model but can also collectively perform, for a plurality of non-response categories, the processing of generating a plurality of pieces of non-response target information using the third language model.

### [3.3.3.4. Fourth Generation Processing Unit 43]

The fourth generation processing unit 43 generates response information, which is information indicating a response to a request indicated by request information, using the generative AI.

For example, the fourth generation processing unit 43 inputs, to the generative AI, as input information, information including instruction information for instructing output of information indicating a response to the request indicated by the request information and information indicating the request included in the request information and causes the generative AI to generate response information.

The request indicated by the request information is, for example, a question of an economic category in the Q & A service and is information of a character string “What is inflation? How does it affect the economy?”. In this case, the fourth generation processing unit 43 inputs, to the generative AI, as input information, information including, as instruction information, information of a character string “As an expert in {category}, you receive and answer questions about {category}” and information including information of a character string “What is inflation? How does it affect the economy?” as information indicating the request included in the request information.

Note that {category} includes information indicating the designated category. The instruction information may include guideline information indicating a guideline for an answer. The guideline information includes information indicating, for example, clarity and neutrality of the answer.

The processing of the fourth generation processing unit 43 may include a part or all of the functions of the determination unit 35. In this case, the fourth generation processing unit 43 functions as a part or the entire determination unit 35 in addition to the function of the generation unit 32 that generates response information using the generative AI.

For example, the fourth generation processing unit 43 may have processing of determining whether the request indicated by the request information received by the reception unit 31 is a request concerning the second target set as a response target. In this case, the fourth generation processing unit 43 includes processing of the generation unit 32 and processing of the determination unit 35.

For example, by inputting, to the generative AI, as input information, information including instruction information for instructing generation of information indicating a response to a request indicated by request information when the request indicated by the request information received by the reception unit 31 is a request concerning the second target, the fourth generation processing unit 43 can cause the generative AI to generate response information when the request indicated by the request information is a request concerning the second target.

For example, when the determination unit 35 determines that the request indicated by the request information is not a request concerning the first target, by inputting to the generative AI, as input information, information including instruction information for instructing generation of information indicating a response to the request indicated by the request information when the request is a request concerning the second target, the fourth generation processing unit 43 can collectively perform determination processing as to whether the request is a request concerning the second target and generation processing for response information.

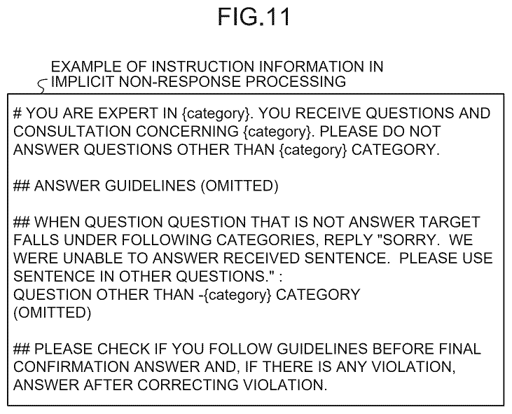

FIG. 11 is a diagram illustrating an example of instruction information used for explicit non-response determination processing performed by the fourth generation processing unit 43 of the processing unit 12 in the information processing apparatus 1 according to the embodiment as a part of processing of the determination unit 35.

In the example illustrated in FIG. 11, the instruction information included in the input information is, for example, information of a character string “#You are an expert of {category}. You receive questions and consultation concerning {category}. Do not answer questions other than the {category} category”. However, the instruction information is not limited to such an example. Note that {category} includes information indicating the designated category. As the guideline of the answer, an incidental condition that is not limited to the designated category may be further included.

The processing by the fourth generation processing unit 43 may include processing of determining whether the request indicated by the request information received by the reception unit 31 is a request concerning the first target and whether the request is a request concerning the second target. In this case as well, the fourth generation processing unit 43 includes the processing of the generation unit 32 and the processing of the determination unit 35.

For example, when the request indicated by the request information received by the reception unit 31 is not a request concerning the first target and is a request concerning the second target, by inputting, to the generative AI, as input information, information including instruction information for instructing generation of information indicating a response to the request indicated by the request information, the fourth generation processing unit 43 can cause the generative AI to generate response information when the request indicated by the request information is not a request concerning the first target but is a request concerning the second target.

In this case, the input information includes, in addition to the instruction information, request information, information indicating the first target, and information indicating the second target. The instruction information includes, for example, a character string “#You are an excellent AI assistant. Determine whether a given question corresponds to the first subject indicated below, and, when the given question does not correspond to the first target, as an expert in {category}, you receive and answer a question concerning {category}. Do not answer questions other than the {category} category”. However, the instruction information is not limited to such an example. Note that {category} includes information indicating the designated category. The instruction information may include guideline information.

### [3.3.4. Evaluation Unit 33]

The evaluation unit 33 evaluates non-response accuracy for each non-response target information combination that is a combination of two or more pieces of non-response target information among a plurality of pieces of non-response target information generated by the generation unit 32.

For example, the evaluation unit 33 can evaluate non-response accuracy of each non-response target information combination using a plurality of pieces of evaluation request information stored in the evaluation request information storage unit 22 and acquired by the acquisition unit 30.

As explained above, the respective pieces of evaluation request information is information indicating a first request that is a request concerning a non-response target in a designated category, information indicating a second request that is a request concerning a response target in the designated category, or information indicating a third request that is a request concerning the non-response target regardless of the designated category.

The evaluation unit 33 determines whether a request indicated by the evaluation request information is determined as a request concerning a non-response target in explicit non-response determination processing using the non-response target information combination. The explicit non-response determination processing using the non-response target information combination is, for example, processing of using each of the plurality of pieces of non-response target information included in the non-response target information combination as the first target.

When determining that the first request or the third request indicated by the evaluation request information is a request concerning a non-response target in the explicit non-response determination processing using the non-response target information combination, the evaluation unit 33 evaluates the non-response target information combination as 1, otherwise, evaluates the non-response target information as 0.

When determining that the second request indicated by the evaluation request information is not the request concerning the non-response target in the explicit non-response determination processing using the non-response target information combination, the evaluation unit 33 evaluates the non-response target information combination as 1, otherwise, evaluates the non-response target information combination as 0.

The evaluation unit 33 can calculate non-response accuracy by aggregating an evaluation result and dividing the aggregation result by the number of evaluations. The evaluation unit 33 can change weight according to whether the request indicated by the evaluation request information is the first request, the second request, or the third request and aggregate the evaluation result by weighted addition.

Further, the evaluation request information may be limited to information indicating the first request or may be limited to two or more pieces of information among information indicating the first request, information indicating the second request, and information indicating the third request. The evaluation is not limited to 0 and 1 and may be, for example, −1 and 1 or may be a combination of other values.

Even when the determination unit 35 determines, using the keyword-based natural language processing, for example, whether requests indicated by request information from the users U are requests concerning the non-response target in the explicit non-response determination processing using the non-response target information combination, the evaluation unit 33 can evaluate the non-response accuracy of the non-response target information combination using a language model.

For example, the evaluation unit 33 can evaluate the non-response accuracy of the non-response target information combination for each non-response target information combination using the third language model based on information indicating the requests included in the request information from the users U and the determination result by the determination unit 35 by the keyword-based natural language processing.

For example, the evaluation unit 33 inputs, as input information, to the third language model, information including instruction information for instructing determination as to whether any one of two or more pieces of non-response target information indicated by the non-response target information combination is not included in the request information from the user U to cause the third language model to output information indicating non-response accuracy of two or more pieces of response target information indicated by the non-response target information combination.

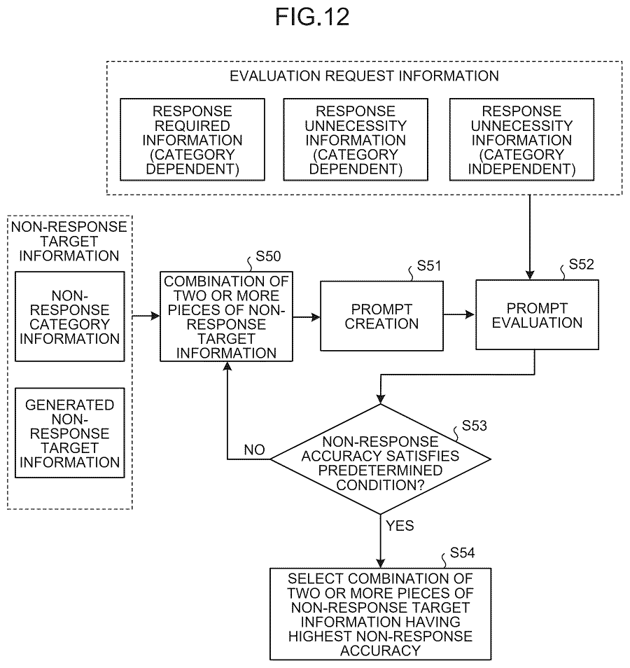

FIG. 12 is a diagram illustrating a flow of processing by the evaluation unit 33 of the processing unit 12 in the information processing apparatus 1 according to the embodiment. As illustrated in FIG. 12, the evaluation unit 33 determines a combination of two or more pieces of non-response target information out of a plurality of pieces of non-response target information (step S50). The combination of the two or more pieces of non-response target information is determined at random or according to a predetermined rule. The combination of two or more pieces of non-response target information may be, for example, a combination including m pieces of non-response target information for each non-response category. m is an integer equal to or larger than 1.

Subsequently, the evaluation unit 33 creates a prompt (input information) including instruction information including the two or more pieces of non-response target information of the combination determined in step S50 (step S51). Then, the evaluation unit 33 performs prompt evaluation for evaluating non-response accuracy of the prompt generated in step S51 as non-response accuracy of the combination of the two or more pieces of non-response target information determined in step S51 (step S52).

In step S52, the evaluation unit 33 inputs information including the prompt generated in step S51 and evaluation request information to the first language model as input information for each piece of evaluation request information and determines, based on information indicating whether the request is a request indicating the first target output from the first language model for each piece of evaluation request information, non-response accuracy of the two or more pieces of non-response target information of the combination determined in step S50.

In the example illustrated in FIG. 12, the respective pieces of evaluation request information are response unnecessary information (category dependent), response necessary information (category dependent), or response unnecessary information (category independent). The response unnecessity information (category dependence) is information indicating a first request that is a request concerning a non-response target in a designated category. The response necessity information (category dependence) is information indicating a second request that is a request concerning a response target in the designated category. The response unnecessary information (category independent) is information indicating a third request that is a request concerning a non-response target regardless of the designated category.

Then, the selection unit 34 explained below determines, based on the evaluation result in step S52, whether the non-response accuracy obtained in step S51 satisfies a predetermined condition (step S53). The predetermined condition is, for example, a condition that non-response accuracy is the highest when the processing of step S50 has ended for all combinations of two or more pieces of non-response target information or a condition that the non-response accuracy is equal to or larger than a threshold but is not limited to such an example.

When it is determined that the non-response accuracy obtained in step S51 satisfies the predetermined condition (step S53: Yes), the selection unit 34 selects a combination of two or more pieces of non-response target information, the non-response accuracy of which obtained in step S51 satisfies the predetermined condition, as two or more pieces of non-response target information used by the determination unit 35.

When the selection unit 34 determines that the non-response accuracy obtained in step S51 does not satisfy the predetermined condition (step S53: No), the evaluation unit 33 shifts the processing to step S50.

### [3.3.5. Selection Unit 34]

The selection unit 34 selects two or more pieces of non-response target information used by the determination unit 35 among a plurality of pieces of non-response target information based on non-response accuracy for each combination of two or more pieces of non-response target information among the plurality of pieces of non-response target information. The plurality of pieces of non-response target information are, for example, non-response category information that is information indicating a non-response category and non-response target information generated by the generation unit 32.

For example, the selection unit 34 selects, based on an evaluation result by the evaluation unit 33, two or more pieces of non-response target information used by the determination unit 35. For example, the selection unit 34 selects a non-response target information combination having the highest non-response accuracy among non-response accuracies of each non-response target information combination as a combination of two or more pieces of non-response target information used by the determination unit 35.

The selection unit 34 can also select a non-response target information combination, non-response accuracy of which for each non-response target information combination is equal to or higher than a threshold, as a combination of two or more pieces of non-response target information used by the determination unit 35 at random or according to a predetermined rule.

### [3.3.6. Determination Unit 35]

The determination unit 35 performs various kinds of determination. For example, the determination unit 35 determines whether to generate response information that is information indicating a response to the request indicated by the request information received by the reception unit 31.

The determination unit 35 determines, based on whether the request indicated by the request information received by the reception unit 31 is a request concerning a first target set as a non-response target and a request concerning a second target set as a response target, whether to generate information indicating a response to the request indicated by the request information received by the reception unit 31.

The first target is, for example, a target set as a non-response target for a designated category that is a category designated by the user U and is a non-response category correlated in advance with the designated category, a non-response target indicated by the non-response target information generated by the generation unit 32, and the like.

The non-response category is, for example, another category (category other than the designated category) in which a boundary with the designated category is ambiguous and a probability of an appropriate response is equal to or smaller than a threshold, and is set in advance for each designated category but is not limited to such an example.

The determination unit 35 performs, for example, based on two or more pieces of non-response target information selected by the selection unit 34, explicit non-response determination processing of determining whether the request indicated by the request information received by the reception unit 31 is a request concerning a first target that is a non-response target.

The two or more pieces of non-response target information selected by the selection unit 34 are two or more pieces of information among the plurality of pieces of non-response category information each indicating the non-response category set in advance in the designated category and the plurality of pieces of non-response target information generated by the generation unit 32.

The first target set as the non-response target includes, for example, a target that does not depend on the designated category in addition to the target set as the non-response target for the designated category. The target that does not depend on the designated category is, for example, violation of a law, violation of social morals, slander, or defamation but is not limited to such an example.

The target that depends on the designated category and the target that does not depend on the designated category may include a target for which a response using the generative AI is not appropriate. The target for which the response using the generative AI is not appropriate is, for example, medical care, health, or finance but is not limited to such an example.

The determination unit 35 can determine, for example, using the first language model, whether the request indicated by the request information received by the reception unit 31 is a request concerning a first target set as a non-response target. The first language model is a large-scale language model such as a transformer-based model or an RNN-based model but is not limited to such an example.

The determination unit 35 inputs, to the first language model, as input information, information including instruction information for instructing output of information indicating whether the request indicated by the request information received by the reception unit 31 is a request concerning the first target and information indicating a request indicated by request information included in a use request. In this case, information indicating whether the request is the request concerning the first target is output from the first language model. As explained above, the determination unit 35 can determine, using the first language model, whether the request indicated by the request information is a request concerning the first target set as the non-response target.

The instruction information includes information indicating an output format. The information indicating the output format includes, for example, information output when the request indicated by the request information is a request concerning the first target and information output when the request indicated by the request information is not a request concerning the first target.

The information output when the request indicated by the request information is a request concerning the first target is, for example, “true” and the information output when the request indicated by the request information is not a request concerning the first target is, for example, “false” but are not limited to such an example.

The information indicating the output format may be information in a format for outputting specific information only when the request indicated by the request information is a request concerning the first target. For example, the information indicating the output format is information of a character string “When the request indicated by the request information is a request concerning the first target, output “correspond”, otherwise, output nothing” but is not limited to such an example. The information indicating the output format may be information indicating a sample of output.

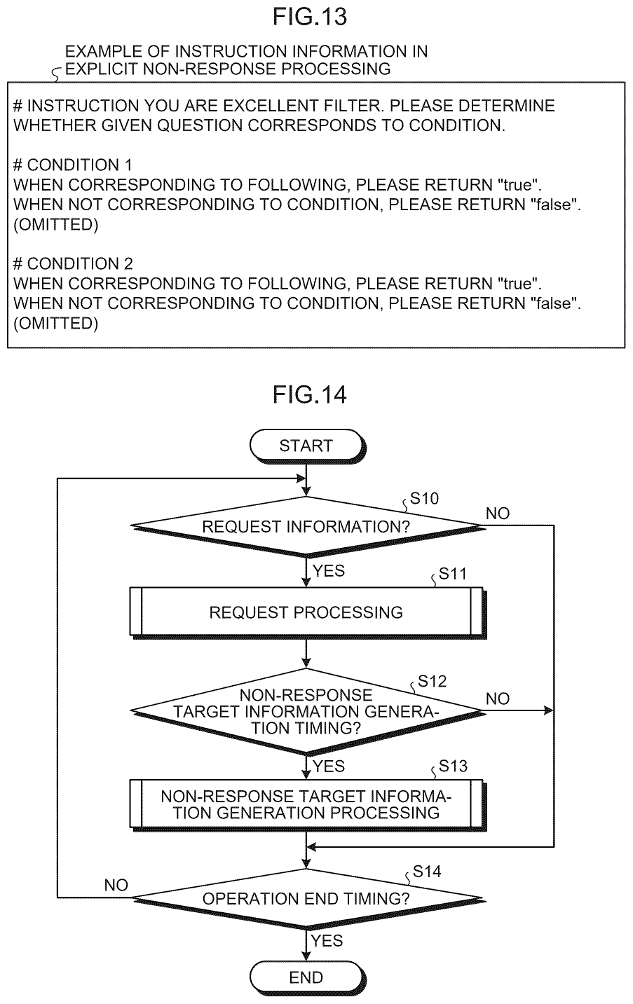

FIG. 13 is a diagram illustrating an example of instruction information used for explicit non-response determination processing by the determination unit 35 of the processing unit 12 in the information processing apparatus 1 according to the embodiment. Although details are omitted in the instruction information illustrated in FIG. 13, information corresponding to a “condition 1” includes information indicating a question concerning a non-response category as information indicating a question concerning the first target and information corresponding to a “condition 2” includes non-response target information generated by the generation unit 32 as information indicating a question concerning the first target but are not limited to such an example.

In the example explained above, the instruction information is included in the input information input to the first language model. However, the first language model may be a language model learned to output, from the input information not including the instruction information, information indicating whether the request indicated by the request information is a request concerning the first target. The first language model may be a language model learned to output, from the input information not including the instruction information and the information indicating the first target, information indicating whether the request indicated by the request information is a request concerning the first target. In these cases, the language model is generated, for example, for each category but is not limited to such an example.

The determination unit 35 can also determine, instead of or in addition to using the first language model, with natural language processing not using the first language model, whether the request indicated by the request information is a request concerning the first target set as the non-response target. The natural language processing not using the first language model is, for example, keyword-based natural language processing. For example, the determination unit 35 includes a first target dictionary including a plurality of keywords each directly or indirectly indicating the first target and determines whether a keyword included in the first target dictionary is included in request information.

When the keyword included in the first target dictionary is included in the request information, the determination unit 35 determines that the request indicated by the request information is a request concerning the first target set as the non-response target, otherwise, determines that the request indicated by the request information is not the request concerning the first target set as the non-response target.

The keyword-based natural language processing may be natural language processing using a model. The model in this case is a model generated by machine learning using learning information including, for each piece of input information, input information and information (label information) indicating whether a request indicated by the input information is a request concerning the first target. Such a model is, for example, GBDT or a neural network but is not limited to such an example.

When determining that the request indicated by the request information received by the reception unit 31 is not a request concerning the first target, the determination unit 35 performs implicit non-response determination processing of determining whether the request indicated by the request information is a request concerning the second target set as the response target.

As explained above, the second target is a target set as the response target. It is determined whether the second target is not a non-response target by determining whether the request is not a request concerning the second target. The second target is considered to be a target implicitly indicating the non-response target. Therefore, as explained above, the second target that is the response target is considered to implicitly indicate a non-response determination criterion and can be considered as an implicit non-response determination criterion. For example, when there is a category designated by the user U, the second target includes a designated category that is such a category.

The determination unit 35 can determine, for example, using the second language model, whether the request indicated by the request information is a request concerning the second target set as the response target. The second language model is, for example, a large-scale language model such as a transformer-based model or an RNN-based model but is not limited to such an example. The second language model may be the same language model as the first language model.

The determination unit 35 inputs, to the second language model, as input information, information including instruction information for instructing output of information indicating whether the request indicated by the request information is a request concerning the second target and information indicating a request indicated by request information included in use request.

In this case, information indicating whether the request is a request concerning the second target is output from the second language model. As explained above, the determination unit 35 can determine, using the second language model, whether the request indicated by the request information is a request concerning the second target set as the response target.

The instruction information includes information indicating the second target. However, the information indicating the second target may be included in the input information separately from the instruction information. The instruction information may include information indicating the request included in the request information.

The instruction information includes information indicating an output format. The information indicating the output format includes, for example, information that is output when the request indicated by the request information is a request concerning the second target and information that is output when the request indicated by the request information is not a request concerning the second target.

The information output when the request indicated by the request information is a request concerning the second target is, for example, “true” and the information output when the request indicated by the request information is not a request concerning the second target is, for example, “false” but are not limited to such an example.

The information indicating the output format may be information in a format for outputting specific information only when the request indicated by the request information is a request concerning the second target. For example, the information indicating the output format is information of a character string “When the request indicated by the request information is a request concerning the second target, output “correspond”, otherwise, output nothing” but is not limited to such an example. The information indicating the output format may be information indicating a sample of output.

In the example explained above, the instruction information is included in the input information input to the second language model. However, the second language model may be a language model learned to output, from the input information not including the instruction information, information indicating whether the request indicated by the request information is a request concerning the second target.

The second language model may be a language model learned to output, from the input information not including the instruction information and the information indicating the second target, information indicating whether the request indicated by the request information is a request concerning the second target.

The determination unit 35 can also determine, instead of or in addition to using the second language model, with natural language processing not using the second language model, whether the request indicated by the request information is a request concerning the second target set as the response target.

The natural language processing not using the second language model is, for example, keyword-based natural language processing. The determination unit 35 includes, for example, a second target dictionary including a plurality of keywords each directly or indirectly indicating the second target and determines whether a keyword included in the second target dictionary is included in the request information.

When the keyword included in the second target dictionary is included in the request information, the determination unit 35 determines that the request indicated by the request information is the request concerning the second target set as the response target, otherwise, determines that the request indicated by the request information is not the request concerning the second target set as the response target.

The keyword-based natural language processing may be natural language processing using a model. The model in this case is a model generated by machine learning using learning information including, for each piece of input information, input information and information (label information) indicating whether a request indicated by the input information is a request concerning the second target. Such a model is, for example, GBDT or a neural network but is not limited to such an example.

Subsequently, the determination unit 35 determines, based on a determination result as to whether the request indicated by the request information received by the reception unit 31 is a request concerning the second target, whether to generate information indicating a response to the request indicated by the request information received by the reception unit 31.

For example, when determining that the request indicated by the request information received by the reception unit 31 is a request concerning the second target, the determination unit 35 determines to generate information indicating a response to the request indicated by the request information.

When determining that the request indicated by the request information received by the reception unit 31 is not a request concerning the second target, the determination unit 35 determines not to generate information indicating a response to the request indicated by the request information.

As explained above, the determination unit 35 first performs explicit non-response determination processing, performs the implicit non-response determination processing when an explicit non-response determination criterion is not satisfied, and performs a response when an implicit non-response determination criterion is not satisfied. Accordingly, the determination unit 35 can perform highly accurate response propriety determination at low cost and can suppress an inappropriate response.

Note that the determination unit 35 can perform the explicit non-response determination processing and the implicit non-response determination processing in parallel. In this case, the determination unit 35 determines, based on a determination result of the explicit non-response determination processing and a determination result of the implicit non-response determination processing, whether to generate information indicating a response to the request indicated by the request information.

In this case, when the request indicated by the request information is not a request concerning the first target and the request indicated by the request information is a request concerning the second target, the determination unit 35 determines to generate information indicating a response to the request indicated by the request information, otherwise, determines not to generate information indicating a response to the request indicated by the request information. This also enables the information processing apparatus 1 to suppress an inappropriate response.

The determination unit 35 can also perform processing in the order of the implicit non-response determination processing and the explicit non-response determination processing. In this case, the explicit non-response determination processing can also be performed only when it is determined in the implicit non-response determination processing that the request indicated by the request information is a request concerning the second target. This also enables the information processing apparatus 1 to suppress an inappropriate response.

As explained above, the determination unit 35 can determine, based on whether the request indicated by the request information is a request concerning the first target set as the non-response target and a request concerning the second target set as the response target, whether to generate information indicating a response to the request indicated by the request information.

### [3.3.7. Provision Unit 36]

The provision unit 36 provides various kinds of information to the user U and the employee O. For example, the provision unit 36 provides various kinds of information to the user U by transmitting the various kinds of information to the terminal device 2 via the communication unit 10 and the network N. The provision unit 36 provides, to the employee O, various kinds of information by transmitting various kinds of information to the terminal device 3 via the communication unit 10 and the network N.

When the determination unit 35 determines to generate the response information, the provision unit 36 provides, to the user U, the response information generated using the generative AI as information indicating a response to the request indicated by the request information received by the reception unit 31.

For example, the provision unit 36 provides the response information generated using the generative AI to the user U by transmitting response information generated using the generative AI generated by the generation unit 32 to the terminal device 2 that has transmitted a use request.

For example, when the request indicated by the request information is a question of a Q & A service and the user U accesses a page indicating an answer to the question of the user U, the provision unit 36 can provide, to the user U, a page indicating an answer to the question of the user U.

When response information is not generated using the generative AI in the generation unit 32, the provision unit 36 provides non-response information to the user U. For example, when the determination unit 35 determines that the request indicated by the request information is a request concerning the first target or when the determination unit 35 determines that the request indicated by the request information is not a request concerning the second target, the provision unit 36 provides the non-response information to the user U.

The non-response information is, for example, information of character information “Sorry. The target is a non-response target and we cannot respond to the request”. For example, when the request indicated by the request information is a request of a Q & A service, the non-response information is, for example, information of character information “Sorry. We cannot answer the question because the question is a question not to be answered”. Note that the non-response information may include information clearly indicating that the request is a request concerning the first target or is not a request concerning the second target.

### [4. Processing Procedure]

Subsequently, a procedure of information processing by the processing unit 12 of the information processing apparatus 1 according to the embodiment is explained. FIG. 14 is a flowchart illustrating an example of the information processing by the processing unit 12 of the information processing apparatus 1 according to the embodiment.

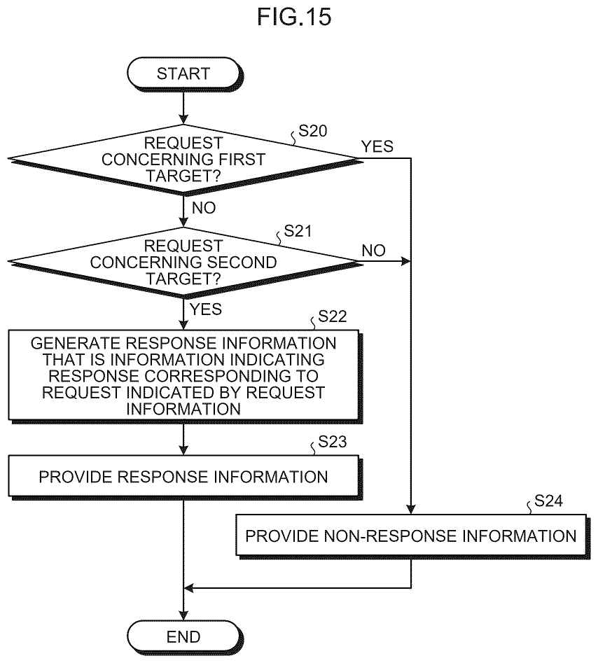

As illustrated in FIG. 14, the processing unit 12 of the information processing apparatus 1 determines whether request information has been received (step S10). When determining that request information has been received (step S10: Yes), the processing unit 12 performs request processing (step S11). The request processing in step S11 is processing in steps S20 to S24 illustrated in FIG. 15 and is explained in detail below.

When the processing in step S11 ends or when determining that request information has not been received (step S10: No), the processing unit 12 determines whether non-response target information generation timing has come (step S12). The non-response target information generation timing is, for example, timing when a generation request is received from the terminal device 3 or timing when the generation request arrives at a predetermined cycle but is not limited to such an example.

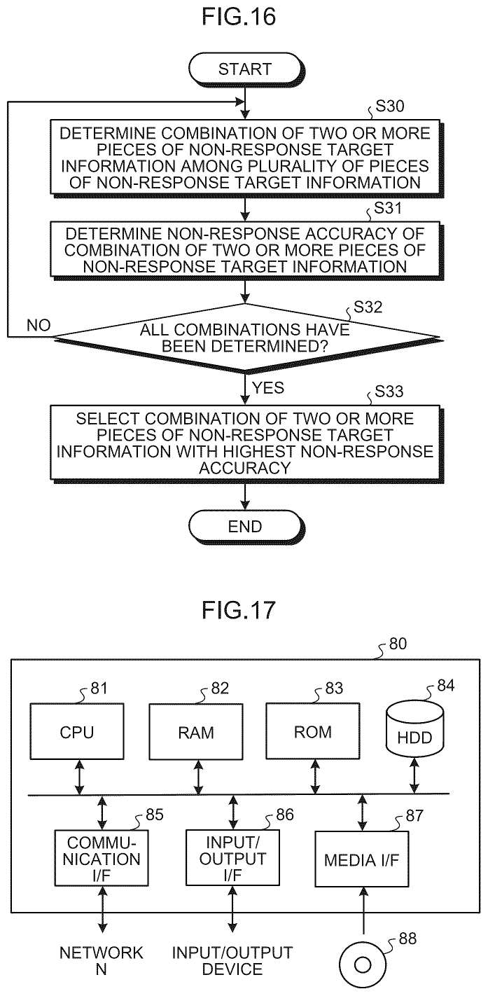

When determining that the non-response target information generation timing has come (step S12: Yes), the processing unit 12 performs non-response target information generation processing (step S13). The non-response target information generation processing in step S13 is processing in steps S30 to S33 illustrated in FIG. 16 and is explained in detail below.

When the processing in step S13 ends, when determining that the non-response target information generation timing has not come (step S12: No), the processing unit 12 determines whether operation end timing has come (step S14). For example, when the information processing apparatus 1 is turned off, the processing unit 12 determines that the operation end timing has come.

When determining that the operation end timing has not come (step S14: No), the processing unit 12 shifts the processing to step S10. When determining that the operation end timing has come (step S14: Yes), the processing unit 12 ends the processing illustrated in FIG. 14.

FIG. 15 is a flowchart illustrating an example of request processing by the processing unit 12 of the information processing apparatus 1 according to the embodiment. As illustrated in FIG. 15, the processing unit 12 of the information processing apparatus 1 determines whether the request indicated by the request information determined as being received in step S10 is a request concerning the first target (step S20).

Subsequently, when determining that the request indicated by the request information is not a request concerning the first target (step S20: No), the processing unit 12 determines whether the request indicated by the request information is a request concerning the second target (step S21). When determining that the request indicated by the request information is a request concerning the second target (step S21: Yes), the processing unit 12 generates response information that is information indicating a response corresponding to the request indicated by the request information (step S22). Then, the processing unit 12 provides the response information generated in step S22 (step S23).

When determining that the request indicated by the request information is a request concerning the first target (step S20: Yes) or when determining that the request indicated by the request information is not a request concerning the second target (step S21: No), the processing unit 12 provides non-response information (step S24).

FIG. 16 is a flowchart illustrating an example of non-response target information generation processing by the processing unit 12 of the information processing apparatus 1 according to the embodiment. As illustrated in FIG. 16, the processing unit 12 determines a combination of two or more pieces of non-response target information among a plurality of pieces of non-response target information (step S30).

Subsequently, the processing unit 12 determines non-response accuracy of a combination of two or more pieces of non-response target information (step S31). Then, the processing unit 12 determines whether all combinations of two or more pieces of non-response target information have been determined (step S32).

When determining that not all the combinations have been determined (step S32: No), the processing unit 12 shifts to step S30. When determining that all the combinations have been determined (step S32: Yes), the processing unit 12 selects a combination of two or more pieces of non-response target information having the highest non-response accuracy as information used in the explicit non-response determination processing (step S33) and ends the processing illustrated in FIG. 16.

### [5. Modifications]

In the example explained above, the generative AI is explained as the text generative AI. However, the generative AI is not limited to the text generative AI and may be image generative AI, multimodal generative AI, or the like. The image generative AI is AI that generates an image from text and is, for example, StackGAN (Generative Adversarial Networks), AttnGAN, T2I (Text-to-Image) with Transformers, or a Diffusion model but is not limited to such an example. Examples of the Diffusion model include DALL-E and Stable-Diffusion.

The multi-modal generative AI is, for example, generative AI that generates at least one of text, an image, and voice from at least one of text, an image, and voice. The multi-modal generative AI is, for example, GPT-4 Turbo with vision, gemini, or CM3Leon (Chameleon Multimodal Model) but is not limited to such an example.

In the example explained above, an example is explained in which the non-response category corresponding to the designated category is set in advance as the first target. However, the present invention is not limited to such an example. A non-response target corresponding to the designated category may be set in advance as the first target instead of the non-response category corresponding to the designated category. In this case as well, the generation unit 32 can also generate non-response target information with the same processing as the processing in the case of the non-response category based on the information indicating the non-response target set in advance as the first target in the designated category.

### [6. Hardware Configuration]

The information processing apparatus 1 according to the embodiment explained above is implemented by, for example, a computer 80 having a configuration illustrated in FIG. 17. FIG. 17 is a hardware configuration diagram illustrating an example of the computer 80 that implements the functions of the information processing apparatus 1 according to the embodiment. The computer 80 includes a CPU 81, a RAM 82, a ROM (Read Only Memory) 83, a HDD (Hard Disk Drive) 84, a communication interface (I/F) 85, an input/output interface (I/F) 86, and a media interface (I/F) 87.

The CPU 81 operates based on a program stored in the ROM 83 or the HDD 84 and controls the units. The ROM 83 stores a boot program to be executed by the CPU 81 when the computer 80 is started, a program depending on hardware of the computer 80, and the like.

The HDD 84 stores a program to be executed by the CPU 81, data to be used by the program, and the like. The communication interface 85 receives data from other devices via the network N (see FIG. 2), sends the data to the CPU 81, and transmits data generated by the CPU 81 to the other devices via the network N.

The CPU 81 controls output devices such as a display and a printer and an input device such as a keyboard or a mouse via the input/output interface 86. The CPU 81 acquires data from the input device via the input/output interface 86. The CPU 81 outputs the generated data to the output device via the input/output interface 86.

The media interface 87 reads a program or data stored in the recording medium 88 and provides the program or the data to the CPU 81 via the RAM 82. The CPU 81 loads the program from the recording medium 88 onto the RAM 82 via the media interface 87 and executes the loaded program. The recording medium 88 is, for example, an optical recording medium such as a DVD (Digital Versatile Disc) or a PD (Phase change rewritable Disk), a magneto-optical recording medium such as an MO (Magneto-Optical disk), a tape medium, a magnetic recording medium, or a semiconductor memory.

For example, when the computer 80 functions as the information processing apparatus 1 according to the embodiment, the CPU 81 of the computer 80 implements the function of the processing unit 12 by executing the program loaded on the RAM 82. The HDD 84 stores data in the storage unit 11. The CPU 81 of the computer 80 reads these programs from the recording medium 88 and executes the programs. However, as another example, these programs may be acquired from another device via the network N.

### [7. Others]

Among the respective kinds of processing explained in the embodiment explained above, all or a part of the processing explained as being automatically performed can be manually performed or all or a part of the processing explained as being manually performed can be automatically performed by a publicly-known method. Besides, the processing procedures, the specific names, and the information including the various data and the parameters explained and illustrated in the above document and the drawings can be optionally changed except when specifically noted otherwise. For example, the various kinds of information illustrated in the figures are not limited to the illustrated information.

The components of the devices illustrated in the figures are functionally conceptual and are not always required to be physically configured as illustrated in the figures. That is, specific forms of distribution and integration of the devices are not limited to the illustrated form. All or a part of the devices can be functionally or physically distributed and integrated in any unit according to various loads, usage conditions, and the like.

The configuration of the information processing apparatus 1 explained above can be flexibly changed; for example, the information processing apparatus 1 may be implemented by a terminal device and a server computer, may be implemented by a plurality of server computers, or may be implemented by calling an external platform or the like with an API, network computing, or the like depending on functions.

The embodiment and the modifications explained above can be combined as appropriate within a range in which contradiction of the processing contents is not caused.

### [8. Effects]

As explained above, the information processing apparatus 1 according to the embodiment includes the generation unit 32, the reception unit 31, and the determination unit 35. The generation unit 32 generates non-response target information indicating a non-response target. The reception unit 31 receives information indicating a request of the user U. The determination unit 35 determines, based on a plurality of pieces of non-response target information generated by the generation unit 32, whether the request indicated by the information received by the reception unit 31 is a request concerning the non-response target. Accordingly, the information processing apparatus 1 can suppress an inappropriate response.

The generation unit 32 generates non-response target information based on non-response category information indicating a non-response category that is a category different from a designated category that is a category designated by the user U, the non-response category being correlated with the designated category in advance as a non-response category. Accordingly, the information processing apparatus 1 can further suppress an inappropriate response.

The generation unit 32 generates non-response target information using a language model. Accordingly, the information processing apparatus 1 can further suppress an inappropriate response.

The generation unit 32 generates information indicating a risk in the non-response category as the non-response target information using the language model. Accordingly, the information processing apparatus 1 can further suppress an inappropriate response.

The generation unit 32 includes the first generation processing unit 40 that generates risk information indicating a risk in the non-response category using the language model and the second generation processing unit 41 that aggregates the risk information generated by the first generation processing unit 40 into a preset or less number of pieces of risk information as the non-response target information using the language model. Accordingly, the information processing apparatus 1 can further suppress an inappropriate response.

The generation unit 32 generates information partially including feature words extracted from the non-response category information as the non-response target information using the language model. Accordingly, the information processing apparatus 1 can further suppress an inappropriate response.

The information processing apparatus 1 includes the selection unit 34 that selects, based on non-response accuracy for each combination of two or more pieces of non-response target information among a plurality of pieces of non-response target information generated by the generation unit 32, two or more pieces of non-response target information used by the determination unit 35 among the plurality of pieces of non-response target information. The determination unit 35 determines, based on the two or more pieces of non-response target information selected by the selection unit 34, whether the request indicated by the information received by the reception unit 31 is a request concerning a non-response target. Accordingly, the information processing apparatus 1 can further suppress an inappropriate response.

The information processing apparatus 1 includes the evaluation unit 33 that evaluates non-response accuracy for each combination of two or more pieces of non-response target information. The selection unit 34 selects, based on an evaluation result by the evaluation unit 33, two or more pieces of non-response target information used by the determination unit 35. Accordingly, the information processing apparatus 1 can further suppress an inappropriate response.

Although the embodiment of the present application is explained in detail above with reference to the drawings, this is merely an exemplification, and the present invention can be implemented in other forms to which various modifications and improvements are applied based on the knowledge of those skilled in the art such as the aspects described in the disclosure of the invention.

In addition, the “part (section, module, unit)” explained above can be replaced with “means”, “circuit”, or the like. For example, the acquisition unit can be replaced with an acquisition unit or an acquisition circuit.

What is claimed is:

1. An information processing apparatus comprising:
a generation unit configured to generate non-response target information indicating a non-response target;
an reception unit configured to receive information indicating a request of a user; and
a determination unit configured to determine, based on the non-response target information generated by the generation unit, whether the request indicated by the information received by the reception unit is a request concerning the non-response target.

2. The information processing apparatus according to claim 1, wherein
the generation unit generates the non-response target information based on non-response category information indicating a non-response category that is a category different from a designated category that is a category designated by the user, the non-response category being correlated with the designated category in advance as a non-response category.

3. The information processing apparatus according to claim 2, wherein
the generation unit generates the non-response target information using a language model.

4. The information processing apparatus according to claim 3, wherein
the generation unit generates information indicating a risk in the non-response category as the non-response target information using the language model.

5. The information processing apparatus according to claim 4, wherein
the generation unit includes:
a first generation processing unit configured to generate risk information indicating a risk in the non-response category using the language model; and
a second generation processing unit configured to aggregate the risk information generated by the first generation processing unit into a preset number or less risk information as the non-response target information using the language model.

6. The information processing apparatus according to claim 3, wherein
the generation unit generates information partially including a feature word extracted from the non-response category information as the non-response target information using the language model.

7. The information processing apparatus according to claim 2, comprising a selection unit configured to select, based on non-response accuracy for each combination of two or more pieces of the non-response target information among a plurality of pieces of the non-response target information generated by the generation unit, two or more pieces of the non-response target information used by the determination unit among the plurality of pieces of the non-response target information, wherein
the determination unit determines, based on the two or more pieces of non-response target information selected by the selection unit, whether the request indicated by the information received by the reception unit is a request concerning the non-response target.

8. The information processing apparatus according to claim 7, comprising an evaluation unit configured to evaluate non-response accuracy for each combination of the two or more pieces of non-response target information, wherein
the selection unit selects, based on an evaluation result by the evaluation unit, the two or more pieces of non-response target information used by the determination unit.

9. An information processing method executed by a computer, the method comprising:
a generation step of generating non-response target information indicating a non-response target;
a reception step of receiving information indicating a request of a user; and
a determination step of determining, based on the non-response target information generated by the generation step, whether the request indicated by the information received by the reception step is a request concerning the non-response target.

10. A non-transitory computer-readable storage medium storing an information processing program for causing a computer to execute:
a generation procedure of generating non-response target information indicating a non-response target;
a reception procedure of receiving information indicating a request of a user; and
a determination procedure of determining, based on the non-response target information generated by the generation procedure, whether the request indicated by the information received by the reception procedure is a request concerning the non-response target.
